(19) United States
(12) Patent Application Publication
(10) Pub. No.: US 2010/0133729 A1
(43) Pub. Date: Jun. 3, 2010

(54) Method and Apparatus for Manufacturing Wide Mouth Containers

(75) Inventor: Sunil S. Shah, York, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: GRAHAM PACKAGING COMPANY, L.P., York, PA (US)

(21) Appl. No.: 12/325,490

(22) Filed: Dec. 1, 2008

(51) Int. Cl. B29C 49/58; B29C 33/00

(52) U.S. Cl. 264/537; 425/524; 264/523; 425/464

(57) ABSTRACT

A method and system for forming a wide mouth container using a single-step blow molding apparatus. The method and system uses a mold that is adapted to be used in a narrow mouth single-step blow molding apparatus. The method and system increases the number of cavities that can be used in the mold for forming wide mouth containers. This increases the amount of containers that can be made and reduces overall tooling and operational costs.

### BACKGROUND OF THE INVENTION

1. Field of the Invention

The present invention is related to the field of container manufacturing. In particular the present invention relates to the method and apparatus for manufacturing wide mouth containers.

2. Description of the Related Technology

Plastic containers are frequently used due to their durability and lightweight nature. Polyethylene terephthalate (PET) is used to construct many of today's containers. PET containers are lightweight, inexpensive, recyclable and manufacturable in large quantities.

PET containers are used for a variety of products, such as beverages. Often these liquid products, such as juices and isotonics, are placed into the containers while the liquid product is at an elevated temperature, typically between 68° C.-96° C. (155° F.-205° F.) and usually about 85° C. (185° F.). When packaged in this manner, the hot temperature of the liquid is used to sterilize the container at the time of filling. This process is known as hot-filling. The containers that are designed to withstand the process are known as hot-fill containers. The formed containers can also be filled with other liquids or materials at temperatures below the hot fill range.

A variety of methods can be used to manufacture PET containers. One such method is called the “two-step” process. The “two-step” process first involves forming a plastic “preform” for use in the blow molding process.

A plastic preform is typically a tubular shaped object that comprises a finish, a neck and body. An exemplary preform 10 is shown in FIGS. 1 and 2. The preform 10 is first formed in a mold shaped to form the preform 10. With two-step stretch blow molding the preform 10, is prepared from a thermoplastic material, typically by an injection molding process. The illustrated preform 10 in FIGS. 1 and 2 includes the open, threaded end, or finish 18 which becomes the finish 18 of the narrow mouth container and the body 12. The finish 18 is located above the neck 16. Located at the finish 18 is the opening 13. The opening 13, as shown, has a diameter that is less than 48 mm and is intended for forming a narrow mouth container.

After the preform 10 is formed in the two-step process it is then transferred, along with other preforms, to a blow molding machine. The preform is then positioned between two open blow mold halves. The blow mold halves close about the preform and cooperate to provide a cavity into which the preform is blown to form a container. After molding, the mold halves open to release the container. The two-step blow molding process is used in order to manufacture large amounts of containers using the preforms.

Another type of blow molding process is a single-step blow molding process. The single-step blow molding process, in contrast to the two-step blow molding process discussed above, involves forming the preform and the finished container without the need to cool the preform fully to form the preform. The single-step process incorporates the preform injection molding and stretch-blow-molding process steps in the same machine. The sequence is basically the same, except that there is less cooling and reheating of the preform. The preform is injection-molded in a parison mold, removed from the mold at maximum temperature, transferred directly through one or more temperature conditioning stations to achieve the proper blowing temperature, and then transferred at the blowing temperature to a blow mold where the preform is blown into the finished bottle.

Both the single-step and the two-step processes have certain advantages and disadvantages. Among the advantages of a two-step process is that efficient and effective use can be made of both the preform, or parison, forming and blowing stations which need not be integrated. The preform may be molded at a central location and shipped to several plants for blowing and filling. Preforms for a large container take up only 11 cubic inches of shipping space, less than 5 percent of the volume occupied by the finished bottle. Preforms may thus be produced at one location by an experienced custom molder and supplied to a beverage bottler in another location who may operate the blow-molding machine without prior knowledge of melt processing of plastic. However, substantial thermal energy is lost during the total operation, since the preform after formation is cooled down during storage and then reheated at the time of blowing. Moreover, the preforms from storage must be fed to the blowing station, thereby duplicating handling and decreasing potential overall efficiencies.

The single-step process eliminates heat loss and duplicate handling. About 50 percent less energy per bottle is consumed during the reheating portion of the process. In addition, in the single-step process, a continuous mechanical grip is maintained on the neck of each bottle from the preform molding stage to the stretch-blow-molding stages This means that there is no need to release and regrip the bottle, eliminating a possible source of distortion and disfiguration due to contact between the preform and other bodies. In addition, the process maintains the preform temperature very high and achieves a more uniform temperature throughout the wall thickness of the preform, permitting low-pressure blowing with accurate dimensional control reducing processing costs and improving product quality. However, the advantages of the single-step process are mitigated since; the systems are not as rapid as sometimes desired in commercial manufacture.

The two processes described above can be used to make either narrow mouth or wide mouth containers. Wide mouth containers are containers that when finished have an opening that is larger than 48 mms. Typically plastic wide mouth containers are used as jars and have a variety of different implementations that narrow mouth containers.

When constructing the wide mouth containers using a single-step process, problems arise due to the creation of excess flash material in the mold and the limited amount of cavities that can be formed in the mold when making the wide mouth containers. When the opening within the mold is designed for use with wide mouth containers, only a limited number of cavities can be formed in the mold as opposed to when a narrow mouth container is formed using the single-step process. This is due to the spatial requirements of the wide mouth containers when the openings are arranged in the mold and the increased requirement of pressure needed in order to close the mold. This can result in the usage of different machinery in order to create narrow mouth and wide mouth containers.

The difference between the usage of narrow mouth container molds and wide mouth container molds are illustrated in FIGS. 3 and 4. FIG. 3 illustrates a single-step mold 60 used with narrow mouth containers having a body forming portion 65, while FIG. 4 illustrates a single-step mold 70 used with wide mouth containers having a body forming portion 75. Each of the respective molds 60 and 70 have similar dimensions with respect to length and width. As can be seen in the FIGURES there are fewer cavities 76 created in the single-step mold 70 than cavities 66 in the single-step mold 60. This is due in part to the large openings 73 needed for the wide mouth container as opposed to the more narrow opening 63 used for the narrow mouth container used during the stretch blow molding process. FIGS. 5 and 6 show top down views of the molds 60 and 70, which illustrate the openings 63 and 73 in order to show the spacing required by the openings in their respective molds.

Furthermore, the wide mouth containers require a higher amount of tonnage, or pressure, in order to keep the mold 70 closed and when closed it may be closed in an inefficient manner. This results in excess flash that requires additional steps in order to remove the flash.

Therefore there is a need in the field to develop a single-step process that can be used to form wide mouth containers without sacrificing the amount of cavities in the mold, or requiring increased tonnage or pressure in order to close the mold.

### SUMMARY OF THE INVENTION

An object of the present invention is a method for making a wide mouth container using a single-step process.

Another object of the invention is a method for making a wide-mouth container using a single-step blow molding apparatus that utilizes a mold having an increased number of cavities.

Yet another object of the invention is a one-step blow molding system that can be utilized to fabricate both narrow mouth and wide mouth containers.

Still yet another object of the invention is a method for making wide mouth containers in a single-single step machine that uses a mold with openings adapted for the receipt of narrow mouth blow molding apparatus injectors.

Yet another object of the invention is a single-step blow molding apparatus that uses a mold that forms a moil.

An aspect of the present invention can be a single step blow molding system comprising: a single step blow molding apparatus: a mold comprising a moil forming portion, a wide mouth container finish forming portion located below the moil forming portion and a body forming portion located below the moil forming portion; and wherein the mold is adapted to receive a narrow mouth blow molding apparatus injector.

Another aspect of the invention can be a method for manufacturing wide mouth containers comprising: providing a mold comprising a moil forming portion, a wide mouth container finish forming portion located below the moil forming portion, and a body forming portion located below the finish forming portion; forming a preform in a one step blow molding apparatus, wherein the preform is located in the mold within an opening adapted to receive a narrow mouth container preform; forming a wide mouth container comprising a body, a wide mouth container finish, a moil and a body; and removing the moil.

Another aspect of the invention can be a mold for use in a single-step blow molding process comprising: an opening having a diameter less than 48 mm, a moil forming portion; a wide mouth container finish forming portion located below the moil forming portion; a body forming portion located below the finish forming portion; and wherein the opening is adapted to receive a single-step blow molding apparatus.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows a preform used in the construction of containers.

FIG. 2 shows a top down view of the preform shown in FIG. 1.

FIG. 3 shows a cross sectional view of a mold used to form narrow mouth containers in a single-step process blow molding apparatus.

FIG. 4 shows a cross-sectional view of a mold used to form wide mouth containers in a single-step blow molding apparatus.

FIG. 5 is a top down view of the mold used to form narrow mouth containers in a two-step process blow molding apparatus.

FIG. 6 is a top down view of a mold used to form wide mouth containers in a single step blow molding apparatus.

FIG. 7 shows a cross-sectional view of a mold used in a two-step blow molding apparatus that employs a narrow necked preform.

FIG. 8 shows a formed wide mouth container with a moil and preform neck still attached to the container.

FIG. 9 shows the wide mouth container shown in FIG. 8 with the moil removed.

FIG. 10 shows a top down view of the container shown in FIG. 8 illustrating the diameter of the container.

FIG. 11 shows a cross-sectional view of a wide mouth container mold for use in a single-step blow molding apparatus in accordance with an embodiment of the present invention.

FIG. 12 illustrates the mold shown in FIG. 9 being employed in a single-step blow mold apparatus.

FIG. 13 is a flow chart showing the steps used in making the wide mouth container in accordance with an embodiment of the present invention.

FIG. 14 is a cross sectional view of mold in accordance with an alternative embodiment of the present invention where both narrow mouth and wide mouth containers are formed.

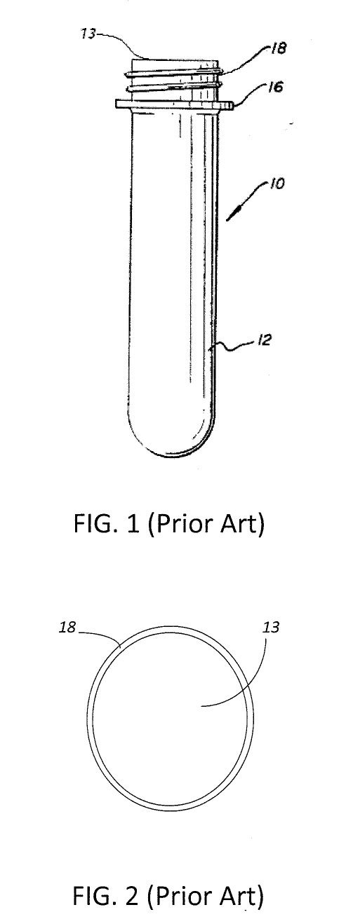

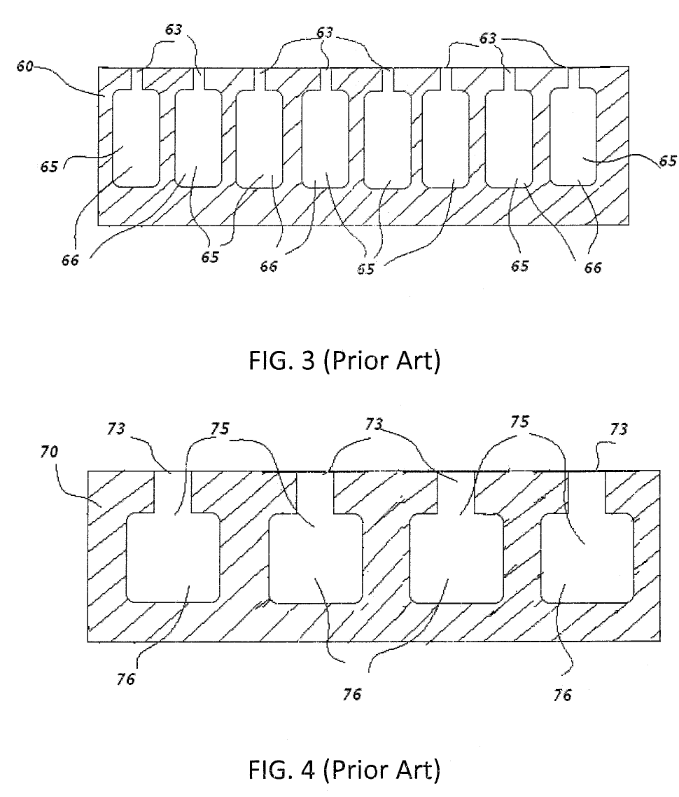

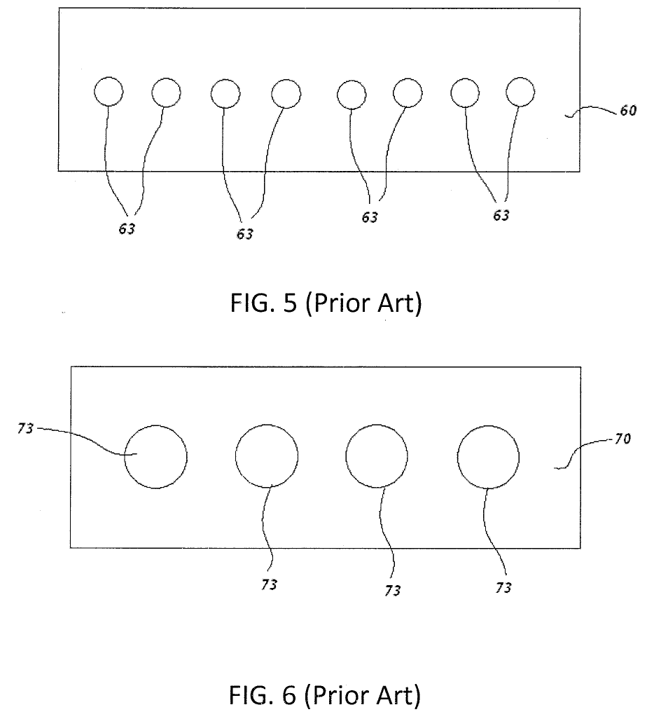

### DETAILED DESCRIPTION OF THE PREFERRED EMBODIMENT(S)

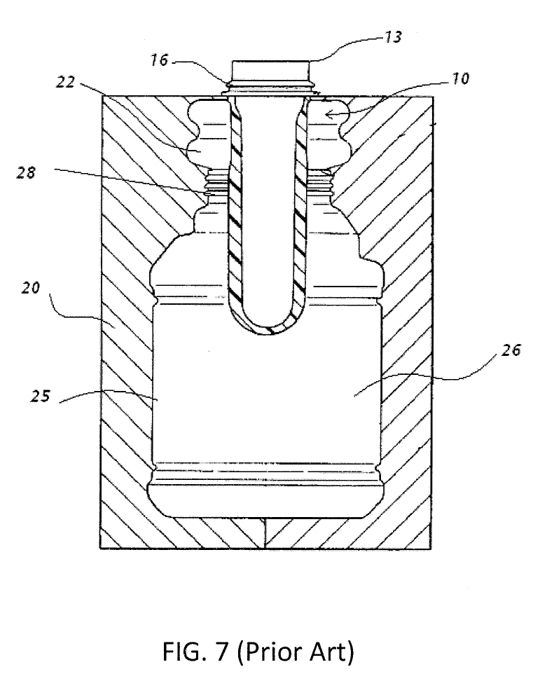

One method of making a wide mouth container is through the use of a two-step process, which is described in U.S. Pat. No. 6,228,317 to Smith et al., the contents of which are herein incorporated by reference. As previously discussed, in the two-step process a preform 10 is formed at some earlier point in a separate manufacturing apparatus and then the preform 10 is shipped to a separate apparatus that is then used to blow mold the container that is intended to be formed. Referring to FIG. 7, shown is a mold 20 that is used in a two-step blow molding process. The preform 10 has a neck 16 and an opening 13 and is placed within the mold 20 having the cavity 26. There is no finish formed on the neck 16. The mold 20 has a moil forming portion 22 located above a wide mouth container finish forming portion 28. The wide mouth container finish forming portion 28 will form the finish 38 that will ultimately be used with the formed container 30. Located below the wide mouth container finish forming portion 28 is the body forming portion 25.

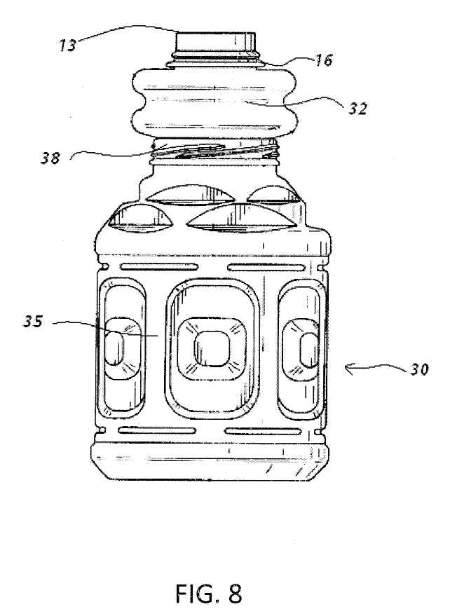

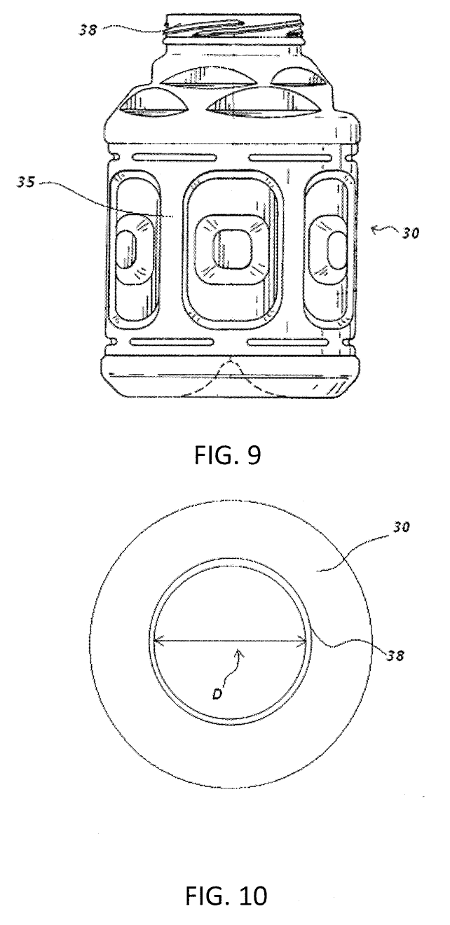

Referring to FIG. 8, after the two-step blow molding process the container 30 is formed. The formed container 30 has a body 35 and wide mouth container finish 38. Located above the wide mouth container finish 38 is a moil 32 that is designed to be removed along with the residual neck 16. FIG. 9 shows the container 30 after the moil 32 has been removed by being sent to a trimmer or some other mechanism for removing it. FIG. 10 is a top down version of the container showing the diameter D of the wide mouth container 30. The diameter D of a wide mouth container is greater than 48 mm.

The formed container 30 may be prepared from a monolayer plastic material, such as a polyamide, for example, nylon; a polyolefin such as polyethylene, for example, low density polyethylene (LDPE), high density polyethylene (HDPE), polypropylene, a polyester, for example, polyethylene terephthalate (PET), polyethylene naphtalate (PEN), or others, which may also include additives to vary the physical or chemical properties of the material. For example, some plastic resins may be modified to improve the oxygen permeability. Alternatively, the container may be prepared from a multilayer plastic material. The layers may be any plastic material, including virgin, recycled and reground material. The layers may include plastics or other materials with additives to improve physical properties of the container. In addition to the above-mentioned materials, other materials often used in multilayer plastic containers include, for example, ethylvinyl alcohol (EVOH) and tie layers or binders to hold together materials that are subject to delamination when used in adjacent layers. A coating may be applied over the monolayer or multilayer material, for example to introduce oxygen barrier properties. In an exemplary embodiment, the present container is prepared from PET.

The blow molded containers 30 may then be filled, with either a cold fill or alternatively, hot-filled, Plastic blow-molded containers, particularly those molded of PET, are utilized in hot-fill applications. Hot-filling involves filling the finished container 30 with a liquid product heated to a temperature in excess of 180° F. (i.e., 82° C.), capped immediately after filling, and then allowed to cool to ambient temperatures.

FIGS 8-10 illustrate how a wide mouth container is formed in a two-step process by using preform and a mold having a moil forming portion. While the usage of the types of molds shown in FIG. 8 have been employed in a two-step process they have not been used in a single-step process. Utilizing a mold that can be employed in the single-step blow apparatus that is adapted to be used in forming wide mouth containers as well as narrow mouth containers is advantageous because it can be used to increase up to 33% increase the number of cavities that can be employed in the mold during the manufacturing process. It also enables the manufacturing of cold/warm fill as well as hot-fill jars on the same single-step machine. This results in lower tooling and operational costs.

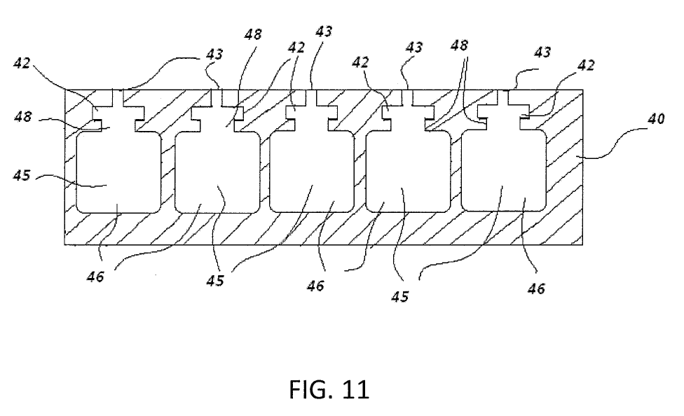

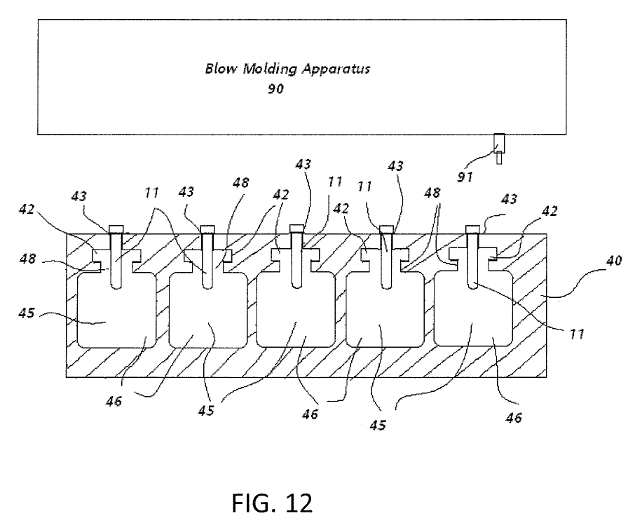

FIGS. 11 and 12 show a cross-sectional view of a wide mouth container mold 40 that is used in the single-step blow molding apparatus 90. In the exemplary wide mouth container mold 40 there are five cavities 46 shown. This is a 25% improvement over the four cavities 76 shown in FIG. 4 and is due to the usage of openings 43 that are able to accommodate a narrow mouth container preform and a narrow mouth blow molding apparatus injector 91.

The mold 40 has a body forming portion 45 that is used to form the body of the finished container. A wide mouth container finish forming portion 48 is formed above the body forming portion 45. The wide mouth container finish forming portion 48 is used to form the finish of the formed container. By having the wide mouth container finish forming portion 48 not directly exposed To the exterior, less force is required in order to close the mold halves for the blow molding process. The wide mouth container finish portion 48 is located below the moil forming portion 42. The moil forming portion 42 is located above the body forming portion 45 and below the opening 43. The moil forming portion 42 forms the moil of the container and is ultimately discarded or recycled. The wide mouth container finish forming portion 48 has a diameter that can form a container having a diameter that is greater than 48 mm.

FIG. 12 shows the mold 40 with the preform 1, created to form the wide mouth container, placed within the cavity 46. The preform 11 has similar features and properties as the preform 10 described above, however it does not necessitate having a finish portion located at the neck. Additionally, the preform 11 used in the single-step process may never be fully cooled to ambient room temperature (which is roughly between 70° F.-75° F.) and is instead merely cooled to an elevated temperature that is sufficient to remove the preform 11 from a preform forming mold.

The blow molding apparatus 90 is also able to be used with narrow mouth containers as well as wide mouth containers because the openings 43 are adapted to receive the narrow mouth blow molding apparatus 91. Therefore the openings 43 have diameters that are sized to be less than 48 mm. The usage of the openings 43 enables spatial arrangement of the cavities 46 in order to increase the number of cavities 46 used as opposed to the number of cavities used in standard single-step wide mouth container blow molding apparatuses. Single-step blow molding apparatuses are known in the field and details of their operation are not described herein. Any portion of the mold can blow narrow neck containers, while the other side is blowing large neck containers with the same preforms.

In the example shown in FIGS. 11 and 12 the number of cavities used are 25% more than those used in standard blow molding apparatuses for forming wide mouth containers. While the example illustrates a 25% improvement it should be understood that improvement in the number of cavities may be increased as much as 33% over those molds typically used The resultant container is similar to the container 30 shown in FIG. 6. It should be understood that the created container is not intended to be limited to that which is shown in FIG. 8 and that the container 30 is only exemplary of the types of containers that may be formed when using the manufacturing method and system described herein.

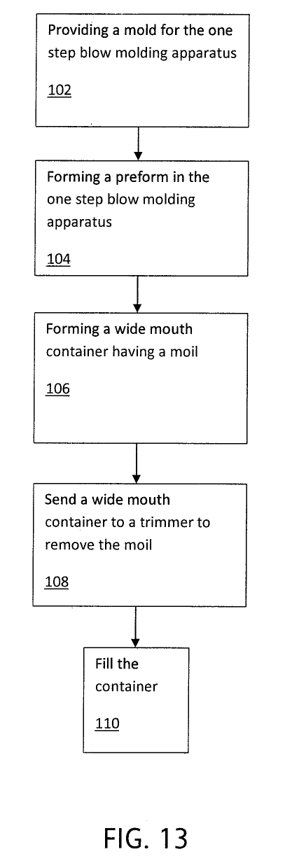

FIG. 13 is a flow chart of the steps used in the single-step blow molding process. In step 102 a mold 40 is provided for the single-step blow molding apparatus 90. In step 104 a preform 11 is formed in the single-step blow molding apparatus 90. In step 106 a wide mouth container 30 is formed having a moil 32. The formed container 30 shown in FIG. 6 is for illustrative purposes only, it should be understood that the wide mouth container may be any shape or form provided that a container having a mouth with a diameter D greater than 48 mm is formed. In step 108 the wide mouth container 30 with the moil 32 is sent to trimmer in order to remove the moil 32. In step 110 the container 30 is filled, which may either be a hot-fill or cold fill.

As discussed previously, the usage of the single-step method for the formation of wide mouth containers results in a system that is able to employ the usage of more cavities per a mold and lower tooling and operation costs. This overcomes the problems found in existing single-step processes used to form wide mouth containers.

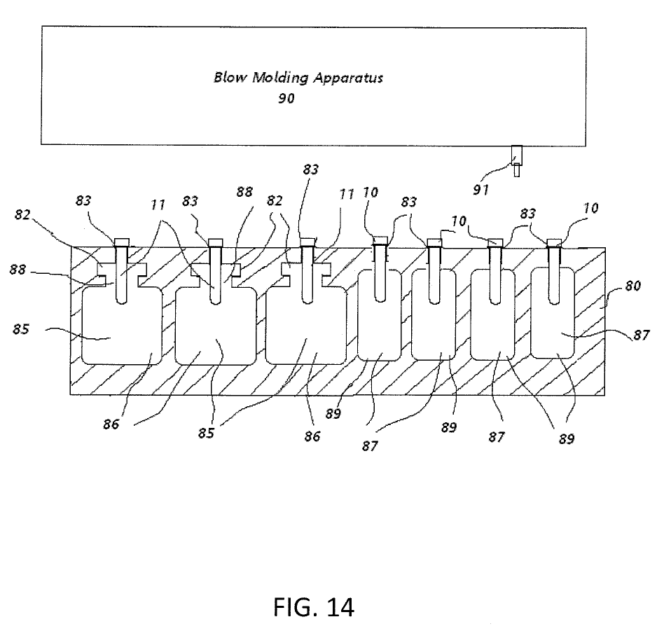

FIG. 14 is a cross sectional view of a mold 80 in accordance with an alternative embodiment of the present invention where both narrow mouth and wide mouth containers can be formed using the same mold 80. In the mold 80 shown in FIG. 14 both preform 10 and preform 11 are used since both narrow mouth and wide mouth containers are formed therein. The preform 10 differs from the preform 11 due to the lack of a finish on the preform 11. Both performs are able to be placed in the openings 83 due to them being sized to hold narrow mouth container performs and adapted to be used with a single-step blow molding apparatus used with narrow mouth containers. There are cavities 86 having body forming portions 85 sized for wide mouth containers and cavities 87 having body forming portions 89 for narrow mouth containers. The mold 80 has wide mouth container finish forming portion 88 formed above the body forming portion 85. The wide mouth container finish forming portion 88 is used to form the finish of the formed wide mouth container. By having the wide mouth container finish forming portion 88 not directly exposed to the exterior, less force is required in order to close the mold halves for the blow molding process. The wide mouth container finish forming portion 88 is located below the moil forming portion 82. The moil forming portion 82 is located below the opening 83. The moil forming portion 82 forms the moil of the container that is ultimately discarded or recycled. The wide mouth container finish forming portion 88 has a diameter that can form a container having a diameter that is greater than 48 mm.

The mold 80 is able to form both narrow mouth and wide mouth containers in the same processing operation in the same mold 80. This enables production of at least two different types of containers using the same mold. It should be understood that more than two different types of containers can be formed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A single-step blow molding system comprising:
a single-step blow molding apparatus:
a mold comprising a moil forming portion, a wide mouth container finish forming portion located below the moil forming portion and a body forming portion located below the moil forming portion; and
wherein the mold is adapted to receive a narrow mouth blow molding apparatus injector.

2. The single-step blow molding system of claim 1, wherein a preform located in the mold has a diameter that is less than 48 mm.

3. The single-step blow molding system of claim 1, wherein the wide mouth container finish forming portion has a diameter that forms a container having a diameter greater than 48 mm.

4. The single-step blow molding system of claim 1, wherein the blow molding apparatus uses PET material or multilayered polypropylene.

5. The single-step blow molding system of claim 1, wherein the mold comprises an opening for receiving the blow molding apparatus injector, wherein the diameter of the opening is smaller than the diameter of the opening of the wide mouth container finish forming portion.

6. The single-step blow molding system of claim 1, wherein the preform does not have a finish.

7. A method for manufacturing wide mouth containers comprising:
providing a mold comprising a moil forming portion, a wide mouth container finish forming portion located below the moil forming portion, and a body forming portion located below the finish forming portion;
forming a preform in a one step blow molding apparatus, wherein the preform is located in the mold within an opening adapted to receive a narrow mouth container preform;
forming a wide mouth container comprising a body, a wide mouth container finish, a moil and a body; and
removing the moil.

8. The method for manufacturing wide mouth containers of claim 7, wherein a preform located in the mold has a diameter that is less than 48 mm.

9. The method for manufacturing wide mouth containers of claim 7, wherein the wide mouth container finish forming portion has a diameter that forms a container having a diameter greater than 48 mm.

10. The method for manufacturing wide mouth containers of claim 7, wherein the blow molding apparatus uses PET material or multilayered polypropylene.

11. The method for manufacturing wide mouth containers of claim 7, wherein the mold comprises an opening for receiving a blow molding apparatus injector, wherein the diameter of the opening is smaller than the diameter of the opening of the wide mouth container finish forming portion.

12. The method for manufacturing wide mouth containers comprising of claim 7, wherein the preform does not have a finish.

13. A mold for use in a single-step blow molding process comprising:
an opening having a diameter less than 48 mm;
a moil forming portion;
a wide mouth container finish forming portion located below the moil forming portion;
a body forming portion located below the finish forming portion; and
wherein the opening is adapted to receive a single-step blow molding apparatus.

14. The mold for use in a single-step blow molding process claim 13, wherein a preform located in the mold has a diameter that is less than 48 mm.

15. The mold for use in a single-step blow molding process of claim 13, wherein the wide mouth container finish forming portion has a diameter that forms a container having a diameter greater than 48 mm.

16. The mold for use in a single-step blow molding process of claim 13, wherein the blow molding apparatus uses PET material or multilayered polypropylene.

17. The mold for use in a single-step blow molding process of claim 13, wherein the opening for receiving the blow molding apparatus injector has a diameter, wherein the diameter of the opening is smaller than the diameter of the opening of the wide mouth container finish forming portion.

18. The mold for use in a single-step blow molding process of claim 13, wherein a preform placed in the opening does not have a finish.

19. The mold for use in a single-step blow molding process of claim 13, further comprising a second body forming portion, wherein the second body forming portion is adapted to form a narrow mouth container.
